(19) United States
(12) Patent Application Publication
(10) Pub. No.: US 2011/0010702 A1
(43) Pub. Date: Jan. 13, 2011

(54) METHOD AND SYSTEM FOR SHARING PACKAGES IN A FRAMEWORK

(75) Inventors: Lohith VRUSHABENDRAPPA, Bangalore (IN); Vala Vanrajsinh Ranjitsinh, Bangalore (IN)

Correspondence Address: North Star Intellectual Property Law, PC, P.O. Box 34688, Washington, DC, 20043, US

(73) Assignee: SAMSUNG ELECTRONICS CO., LTD., Suwon-si (KR)

(21) Appl. No.: 12/826,149

(22) Filed: Jun. 29, 2010

(30) Foreign Application Priority Data
Dec. 31, 2007 (IN) 3161/CHE/2007
Dec. 31, 2008 (KR) PCT/KR2008/007848

(51) Int. Cl. G06F 15/16; G06F 9/445

(52) U.S. Cl. 717/177; 709/217

(57) ABSTRACT

A method and device for specifying multiple packages with a single entry to be shared by a bundle, are provided. A plurality of packages may be associated with an expression. The expression may be included in a description of a bundle that enables deployment of the plurality of packages in the framework. The plurality of packages may be exported by the bundle to the framework which provides an environment for execution of the plurality of packages.

### CROSS-REFERENCE TO RELATED APPLICATIONS

This application is a continuation of International Application PCT/KR2008/007848, filed on Dec. 31, 2008, which claims the benefit of Indian Patent Application No. 3161/CHE/2007, filed on Dec. 31, 2007, in the Indian Patent Office, the entire disclosure of each of which is incorporated herein by reference for all purposes.

### BACKGROUND

1. Field

The following description relates to a method and system for sharing of packages in a framework.

2. Description of Related Art

Open Services Gateway initiative (OSGi) architecture provides a standardized, component-oriented, computing environment for networked devices. The OSGi architecture has a wide range of applications in various fields, for example, mobile devices, home automation, industrial automation, vehicles, telematics, embedded appliances, and the like. The core component of OSGi architecture is the OSGi framework, which provides an execution environment that may be used by OSGi bundles. An OSGi service platform (framework) that is deployed on a networked device provides the network device with the capability to deploy and manage the lifecycle of various software components in a coordinated manner.

The OSGi framework supports the deployment of downloadable and extensible components known as bundles. A bundle refers to a unit of an application that provides services to end users of the networked devices and also to other bundles. An OSGi service is an object from one bundle that may be made available to other bundles. In other words, a service is a mechanism that enables a bundle to provide functionality to other bundles. For example, bundles may be stored in a Java Archive (JAR) file format that is compliant with the widely used Zip file format. OSGi-compliant devices may download and install OSGi bundles and remove them when they are no longer needed.

The framework provides developers with the flexibility to manage the life cycle of bundles by offering the developers the ability to dynamically install, start, stop, update, and uninstall bundles. The framework also provides different optional services such as (conditional) permission admin, package admin, event admin, deployment admin, etc., to help manage the bundles.

The main contents of a bundle are class files, which are the executable part of the bundle. A set of classes may be grouped in a package that may be shared between different bundles in the OSGi framework. The OSGi framework provides a service, known as a package admin service, to manage package-sharing between bundles. Thus, a bundle can export packages to other bundles. Similarly, the bundle may also import packages from other bundles. A developer of a bundle needs to specify the packages the bundle can export to other bundles in the framework. The developer may specify these packages in the manifest file of the bundle. The manifest file describes the contents of bundles and includes information required by the framework to install and activate a corresponding bundle. The manifest file may also include other information such as the dependencies of a bundle.

In the state of the art, a developer of a bundle needs to provide a fully qualified name for each package that may be exported in the manifest file of the bundle. Similarly, the fully qualified names of all the packages that need to be imported need to be specified in the manifest file. Although this can be done rather easily for a small number of packages, specifying the full name of each package may prove to be tedious if a large number of packages need to be exported or imported by a bundle.

### SUMMARY

In one general aspect, there is provided a method for sharing packages in a framework, the method including associating an expression with a plurality of packages, wherein the expression describes the plurality of packages as a single entry, including the expression in a description of a bundle, the bundle enabling deployment of the plurality of packages in the framework, and exporting the plurality of packages by the bundle to the framework, the framework providing an environment for execution of the plurality of packages.

The method may further include analyzing the expression and decoding the expression to a plurality of entries, each entry of the plurality of entries uniquely corresponding to a package of the plurality of packages.

The method may further include receiving the bundle by the framework, and installing the bundle in the framework.

The method may further include importing the plurality of packages in the framework.

The expression may include a regular expression.

The regular expression may include at least one of: “*”, “+”, “[ ]”, and “?”.

The framework may include an Open Service Gateway initiative framework.

In another aspect, there is provided a device, including a processor configured to associate an expression with a plurality of packages such that the expression describes the plurality of packages as a single entry, the expression being included in a description of a bundle configured to enable deployment of the plurality of packages in a framework, and a package-admin-service module configured to export the plurality of packages in the framework configured to provide an environment for execution of the plurality of packages.

The processor may be further configured to analyze the expression and decode the expression into a plurality of entries, each entry of the plurality of entries uniquely corresponding to a package of the plurality of packages.

The expression may include a regular expression.

The regular expression may include at least one of: “*”, “+”, “[ ]”, and “?”.

The framework may include an Open Service Gateway initiative framework.

The device may comprise an Open Service Gateway initiative device.

Other features and aspects may be apparent from the following description, the drawings, and the claims.

### BRIEF DESCRIPTION OF DRAWINGS

FIG. 1 is a diagram illustrating an example of an Open Services Gateway initiative (OSGi) network.

FIG. 2 is a diagram illustrating an example of an OSGi architecture.

FIG. 3 is a diagram illustrating an example of a package admin service deployed in the Service Layer of the OSGi framework.

FIG. 4 is a flowchart illustrating an example of a method of sharing packages in a framework.

FIG. 5 is a flowchart illustrating an example of a method of sharing packages in an OSGi framework.

FIG. 6 is a diagram illustrating an example of a device.

Throughout the drawings and the description, unless otherwise described, the same drawing reference numerals should be understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

Various embodiments facilitate the process of specifying multiple packages that are to be shared, in the form of a single entry in the manifest file of a bundle. A regular expression may be used in the manifest file to specify a set of packages that are to be shared with other bundles in a framework. The regular expressions are analyzed and the corresponding packages that are to be shared are determined. Accordingly, the corresponding packages are exported and/or imported.

As described herein, ordinary characters may refer to alphanumeric characters such as letters and numbers, and special characters may refer to other various characters such as “#”, “$”, “%”, “̂”, “*”, “(”, “)”, “+”, “−”, “[ ]”, and the like.

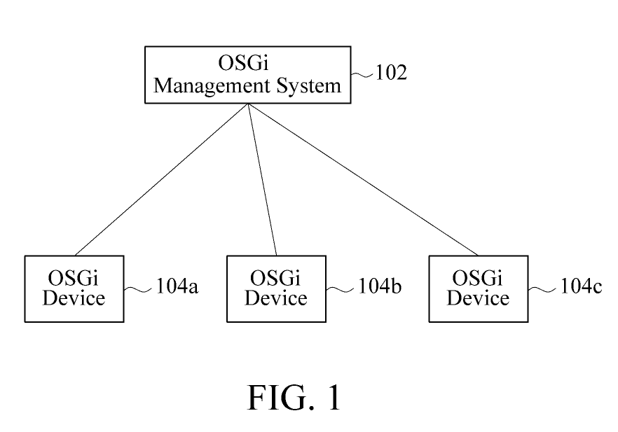

FIG. 1 illustrates an example of an Open Services Gateway initiative (OSGi) network. OSGi network 100 includes an OSGi management system 102 and a plurality of OSGi devices 104a, 104b and 104c, hereinafter referred to as “OSGi devices 104”. OSGi management system 102 may remotely manage the OSGi devices 104.

OSGi devices 104 may all be networked devices that are OSGi compliant. Examples of OSGi devices 104 include, but are not limited to, terminals such as mobile phones, Personal Digital Assistants (PDAs), laptops, desktop computers, embedded appliances, residential gateways, industrial computers, high-end servers, consumer electronic devices, and the like.

OSGi devices 104 may download a bundle from a developer or a vendor. OSGi management system 102 manages the lifecycle of the bundle, which may be installed, started, updated, stopped or uninstalled. Accordingly, various functions and features of the device can be managed. OSGi management system 102 may remotely manage the devices using an appropriate remote management protocol. Examples of such remote management protocols include Simple Network Management Protocol (SNMP), Common Management Information Service Element (CMISE), Telnet, Common Information Model (CIM), Open Mobile Alliance Device Management (OMA DM), and the like.

Though, the above described example is explained as an OSGi network, it should be apparent that the efficient sharing of packages may be employed on any other suitable network.

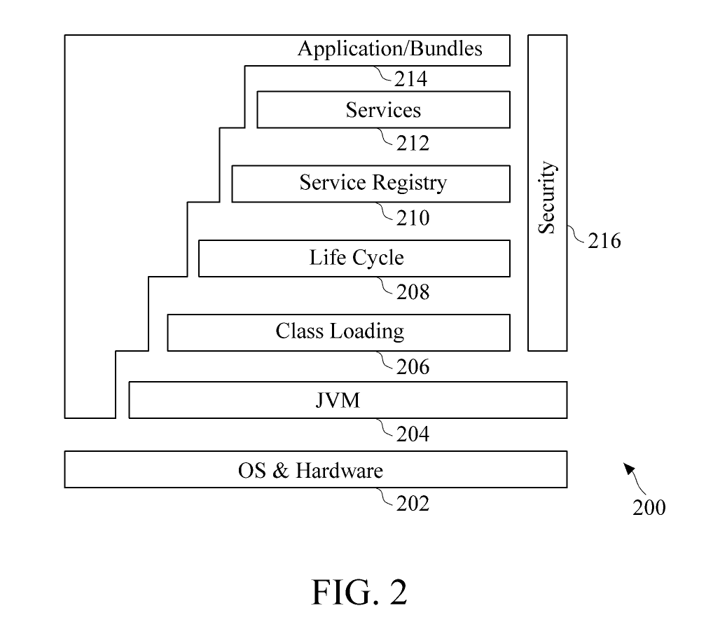

FIG. 2 illustrates an example of an OSGi architecture. An OSGi architecture 200 includes an operating system (OS) & hardware layer 202, a Java™ Virtual Machine (JVM) layer 204, a class-loading layer 206, a life cycle layer 208, a service registry layer 210, a services layer 212, an application layer 214, and a security layer 216.

OS & hardware layer 202 is the lowest layer and provides an execution environment (for JVM) in the OSGi architecture. The operating system may be, for example, Unix, Windows, and the like. The operating system runs on top of a hardware platform. JVM layer 204 provides a runtime environment for the operation of the OSGi framework. NM is a runtime engine that supports Java™ programming language that is a product of SUN MICROSYSTEMS®, Inc. of Santa Clara, Calif. In conventional methods, a single Java™ application runs on one JVM. However, in OSGi framework, several bundles may run on the same JVM, because the OSGi framework provides a cooperative environment, where the bundles behave cooperatively according to OSGi specifications.

Class-loading layer 206 defines the class-loading policies for bundles. The main contents of a bundle are its class files. These class files are the executable part of a bundle. A set of classes may be grouped in a package. The packages may be shared between different bundles in the OSGi framework. Above the class-loading layer 206 is the cycle layer 208.

Life cycle layer 208 provides a management Application Program Interface (API) to manage the life cycle of the bundles in the OSGi framework. The bundles may be dynamically installed, started, stopped, updated and uninstalled. Life cycle operations are protected with security architecture to prevent an attack by malicious bundles. Above the life cycle layer is the service registry layer 210.

Service registry layer 210 enables the sharing of services between bundles. In the OSGi framework, one or more services inside the bundle are registered in a service registry when the bundle is installed, to allow the other bundles to use the one or more services. An OSGi service is an object from a bundle that is made available to other bundles. Accordingly, with the help of service registry, bundles may register objects, search for objects, and receive notifications when new services are registered or existing services are unregistered or modified. Above the service registry layer 210 is the services layer 212.

Services layer 212 provides various standardized and optional services such as permission admin service, conditional permission admin service, package admin service, deployment admin service, and the like, in the OSGi framework. These services enable various functions in the OSGi framework, for example, installation of the bundles, management of permissions associated with the bundles, calculation of the dependencies of the bundles, and the like.

Above services layer 212 is the application layer 214. Application layer 214 provides services to other bundles, which may implement one or more services in the OSGi framework. Additionally, OSGI-compliant bundles may include a manifest file, which describes the contents of the bundles and includes information needed by the framework to install and start a corresponding bundle. Above the application layer 214 is the security layer 216.

Security layer 216 provides a comprehensive security model to enable applications from different sources to run in the OSGi framework. Each bundle has a set of permissions that may be changed dynamically. Upon being set, the new permissions are immediately effective. To prevent attacks made by malicious bundles through package-sharing between bundles, OSGi specifications may contain package permissions that limit export and import to other bundles. Service permissions may be used to ensure that specific services are only used by authorized bundles.

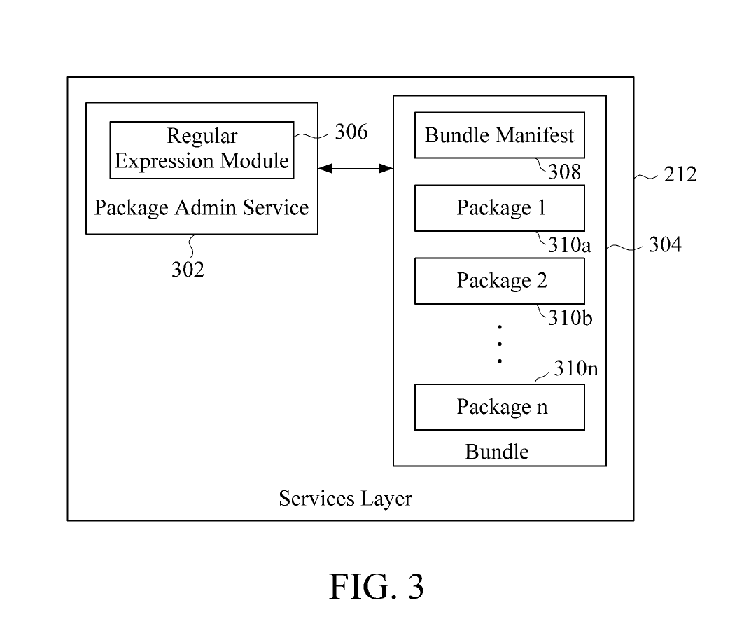

FIG. 3 illustrates an example of a package admin service deployed in services layer of the OSGi framework. Services layer 212 includes a package admin service 302 and a bundle 304. Package admin service 302 includes a regular expression module 306. As discussed in conjunction with FIG. 2, services layer 212 may include other services such as permission admin service, event admin service, and the like.

Bundle 304 includes a bundle manifest 308 and a plurality of packages, a “package 1” 310a, a “package 2” 310b, and a “package n” 310n. Bundle manifest 308 is the manifest file associated with bundle 304.

In the OSGi framework, one or more services included in a bundle may be shared with other bundles through an export-import mechanism. A first bundle may export a package to enable a second bundle to access the classes contained in the package. The second bundle, in turn, may import the package to access the classes contained in the package.

Bundle manifest 308 may include information related to the contents of the bundle, as well as information that is used by the OSGi framework to install and start bundle 304. Bundle manifest 308 may also include information related to the export and import of packages. In some embodiments, bundle manifest 308 may include one or more export statements and one or more import statements, in accordance with regular expression syntax. For example, a regular expression may specify a set of strings that matches the expression. Further, the regular expression may use both ordinary and special characters. The special characters include, for example, “*”, “?”, “[ ]”, “+”, and the like. These special characters may be used in conjunction with package names in the manifest file of the bundle. Each special character may be resolved in accordance with predefined rules.

Package Admin service 302 provides information about the actual package-sharing state of bundles. The sharing of packages between the bundles creates a set of dependencies between the bundles. Package admin service 302 manages the dependencies of the bundles in the dynamic environment provided by the OSGi framework. Whenever the state of a bundle changes, for example, when a bundle is installed, updated or uninstalled, package admin service 302 recalculates the dependencies between the bundles and establishes the sharing between the bundles. Accordingly, the packaged admin service 302 may dynamically manage the dependencies of the bundles.

Referring to FIG. 3, when bundle 304 changes its state, for example, bundle 304 is installed, updated or uninstalled, package admin service 302 receives a notification generated in the OSGi framework. Package admin service 302 retrieves the information related to sharing of packages from bundle manifest 308. Package admin service 302 executes one or more import statements and one or more export statements included in the manifest. Package admin 302 provides a regular expression received from bundle manifest 308 to regular expression module 306.

The regular expression module 306 may analyze and decode the regular expression to determine a plurality of packages specified by the regular expression. The packages that match the regular expression may be exported and imported accordingly. The regular expression that includes one or more special characters may be resolved into a plurality of packages, in accordance with predefined rules. The use of the regular expression to specify a plurality of packages is explained in conjunction with the following examples.

For example, a developer of a bundle may offer three packages, com.abc.package1, com.abc.package2 and com.abc.package3, each of which may be exported. In this example, instead of providing individual export statements specifying the fully qualified name of each package, the developer may include a single export statement, “com.abc.package*”, in the manifest file of the bundle. The bundle may pass the regular expression to regular expression module 306, when package admin service 302 finds the regular expression in the manifest file of the bundle. Regular expression module 306 may resolve the regular expression, “com.abc.package*”, into three packages, for example, com.abc.package1, com.abc.package2 and com.abc.package3. These three packages may then be exported to other bundles in the framework.

Examples of regular expressions include, but are not limited to, “com.abc.package*”, “com.*”, “*”, and the like. The expression, “com.abc.package*”, may refer to all the packages inside a bundle that start with package name, for example, com.abc.package1, com.abc.package2, and com.abc.package3.example, and so forth. The expression, “com.*”, may refer to all the packages that are recursively included under com, while “*”, may refer to all the packages inside the bundle.

In another example, the developer provides a number of packages, i.e., com.abc.package1, com.abc.package2, com.abc.package3, com.abc.package4, com.abc.package.example1, com.abc.package.example2, and com.abc.package.example3 in a bundle. For example, if the developer wants to export all the packages that start with the name com.abc.package, the developer may include a single export statement, “com.abc.package*”, in the manifest file of the bundle. In this example, all packages mentioned above will be exported. In another embodiment, if the developer wants to export only the packages com.abc.package1, com.abc.package2, com.abc.package3 and com.abc.package4, the developer may include single export statement, “com.abc.package?”. In yet another embodiment, if the developer wants to export only the packages com.abc.package1 and com.abc.package2, the developer may include a single export statement, “com.abc.package [1, 2]”. Similarly, a single import statement may be included in the manifest file of the bundle to specify the packages that need to be imported by a bundle. As result, a plurality of packages may be selectively specified from a set of packages, without providing the full name for each individual package. It should be appreciated that other suitable regular expression may also be used to specify the packages that need to be exported or imported by a bundle.

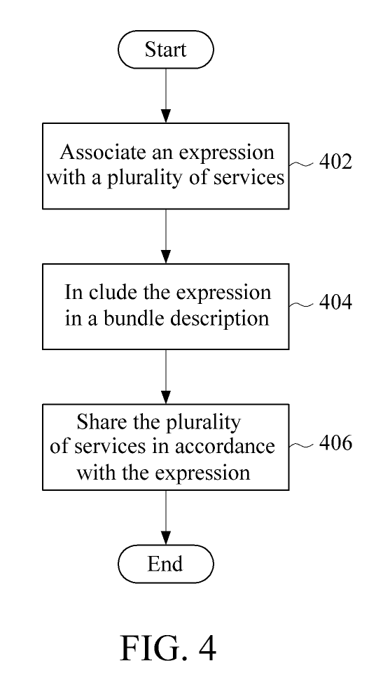

FIG. 4 illustrates an example of sharing packages in a framework. Examples of the framework include, but are not limited to, Mobile Information Profile (MIDP) framework, Xlets framework, and the like. The method for sharing packages may include more or less number of packages as depicted in FIG. 4.

In operation 402, a regular expression is associated with a plurality of packages offered by a bundle. As used herein, a package refers to a package that can be exported by a bundle that is to be used by the other bundles in the OSGi framework. In general, a regular expression may specify a set of strings that matches the expression. The regular expression may use both ordinary and special characters. The special characters may include, for example, “*”, “?”, “[ ]”, “+”, and the like. These special characters may be used in conjunction with package names in the manifest file of the bundle. Each special character may be resolved in accordance with predefined rules, such that a regular expression specifies a set of strings. Therefore, the regular expression that includes one or more special characters may be resolved into a plurality of packages, in accordance with predefined rules.

In operation 404, the expression is included in the manifest file of the bundle. One or more export statements and one or more import statements may be specified, in accordance with regular expression syntax. In operation 406, the packages that match the regular expression are shared with other bundles. For example, the packages that match the regular expression may be exported or imported.

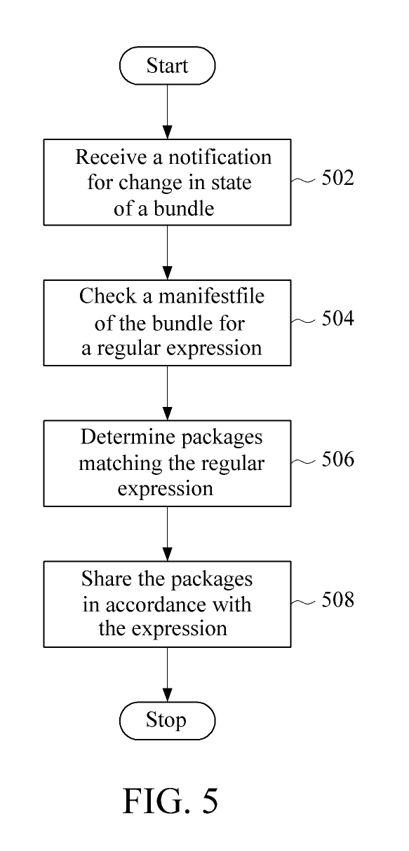

FIG. 5 illustrates an example of sharing packages in an OSGi framework.

In operation 502, a notification regarding the change in the state of a bundle is received. In some embodiments, a bundle may be received along with the notification. The bundle may be installed, updated, or uninstalled in the OSGi framework. Each of these events generates a notification in the OSGi framework.

The bundle includes a bundle manifest that includes information related to the contents of the bundle, as well as information used by the OSGi framework to install and start the bundle. The bundle manifest also includes information related to the export and import of packages. The bundle manifest may include one or more export statements, in accordance with regular expression syntax. In general, a regular expression specifies a set of strings that matches the expression. The regular expression may include both ordinary and special characters. The special characters may include, for example, “*”, “?”, “[ ]”, “+”, etc. These special characters may be used in conjunction with the package names in the manifest file of the bundle. Each special character may be resolved in accordance with predefined rules, such that a regular expression specifies a set of strings. Similarly, the bundle manifest may include one or more import statements, in accordance with regular expression syntax.

In operation 504, the bundle manifest of the bundle is retrieved. The information related to the sharing of packages is retrieved from the bundle manifest. In operation 506, one or more import statements and one or more export statements, included in the manifest, are executed. One or more import statements and one or more export statements may be in the regular expression syntax. A regular expression received from a bundle manifest may be analyzed and decoded to determine a plurality of packages specified by the regular expression. The packages that match the regular expression may be exported and imported accordingly. The regular expression, including one or more special characters, is resolved into a plurality of packages, in accordance with predefined rules. In operation 508, the packages determined in operation 506 are shared in the OSGi framework.

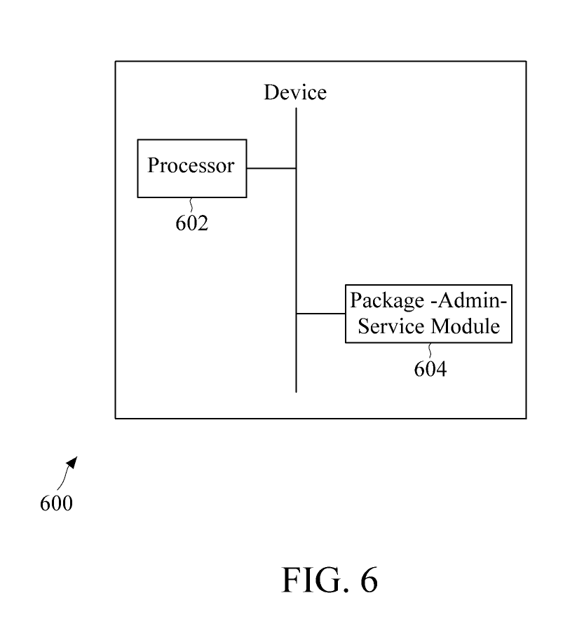

FIG. 6 illustrates an example of a device. Device 600 includes a processor 602 and a package-admin service module 604. An example of device 600 includes, but is not limited to, an Open Services Gateway initiative (OSGi) device such as a terminal. Processor 602 is configured to associate an expression with a plurality of packages. The expression may describe the plurality of packages as a single entry. An example of the expression includes, but is not limited to, a regular expression. Examples of the regular expression include, but are not limited to, “*”, “+”, “[ ]”, and “?”.

Processor 602 is also configured to include the expression in a description of a bundle. An example of the framework includes, but is not limited to, an Open Services Gateway initiative (OSGi) framework. The bundle enables deployment of the plurality of packages in a framework. Package-admin service module 604 is configured to export the plurality of packages in the framework. The framework provides an environment for execution of the plurality of packages. According to various embodiments, processor 602 is also configured to analyze the expression and decode the expression to a plurality of entries. Each entry of the plurality of entries uniquely corresponds to a package of the plurality of packages.

Described herein is a framework that allows multiple export/import packages as to be labeled a single entry in the manifest file of a bundle. Accordingly, an efficient sharing of packages between bundles in an OSGi framework may be performed. In addition, multiple packages that are to be exported by a bundle may be specified through a single entry in a manifest file of the bundle. The framework also facilitates the process of specifying multiple packages that need to be imported by a bundle, through a single entry in the manifest file of the bundle.

Accordingly, a more efficient device and method are provided for sharing packages. Packages may be shared by associating an expression with a plurality of packages, wherein the expression describes the plurality of packages as a single entry. The method also includes including the expression in a description of a bundle. The bundle enables deployment of the plurality of packages in the framework. Moreover, the method includes exporting the plurality of packages by the bundle to the framework. The framework provides an environment for execution of the plurality of packages. The method may also include analyzing the expression and decoding the expression to a plurality of entries. Each entry of the plurality of entries uniquely corresponds to a package of the plurality of packages. The device and method provided herein eliminates the need to give a fully qualified name for each package that needs to be imported or exported. This facilitates the developer's work, because the regular expression may be used to include multiple export/import packages. Further, the processing of the bundle is more efficient.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for sharing packages in a framework, the method comprising:
associating an expression with a plurality of packages, wherein the expression describes the plurality of packages as a single entry;
including the expression in a description of a bundle, the bundle enabling deployment of the plurality of packages in the framework; and
exporting the plurality of packages by the bundle to the framework, the framework providing an environment for execution of the plurality of packages.

2. The method of claim 1 further comprising analyzing the expression and decoding the expression to a plurality of entries, each entry of the plurality of entries uniquely corresponding to a package of the plurality of packages.

3. The method of claim 1 further comprising receiving the bundle by the framework, and installing the bundle in the framework.

4. The method of claim 1 further comprising importing the plurality of packages in the framework.

5. The method of claim 1, wherein the expression comprises a regular expression.

6. The method of claim 5, wherein the regular expression comprises at least one of: “*”, “+”, “[ ]”, and “?”.

7. The method of claim 1, wherein the framework comprises an Open Service Gateway initiative framework.

8. A device, comprising:
a processor configured to associate an expression with a plurality of packages such that the expression describes the plurality of packages as a single entry, the expression being included in a description of a bundle configured to enable deployment of the plurality of packages in a framework; and
a package-admin-service module configured to export the plurality of packages in the framework configured to provide an environment for execution of the plurality of packages.

9. The device of claim 8, wherein the processor is further configured to:
analyze the expression; and
decode the expression into a plurality of entries, each entry of the plurality of entries uniquely corresponding to a package of the plurality of packages.

10. The device of claim 8, wherein the expression comprises a regular expression.

11. The device of claim 8, wherein the regular expression comprises at least one of: *, +, [ ], and ?.

12. The device of claim 8, wherein the framework comprises an Open Service Gateway initiative framework.

13. The device of claim 8, wherein the device comprises an Open Service Gateway initiative device.
